(19) United States
(12) Patent Application Publication
(10) Pub. No.: US 2026/0249330 A1
(43) Pub. Date: Aug. 27, 2026

(54) Solid Liquid Separator

(71) Applicant: HONG TAY YUE ENTERPRISE CO., LTD., Kaohsiung (TW)

(72) Inventor: Chin-Da Tsai, Kaohsiung (TW)

(21) Appl. No.: 19/064,733

(22) Filed: Feb. 27, 2025

(51) Int. Cl. B08B 7/02

(52) U.S. Cl. CPC B08B 7/02

(57) ABSTRACT

A solid liquid separator comprises a casing. A buffering mechanism is mounted in the casing and includes a plurality of first buffering members and a plurality of second buffering members. A centrifugal device is received in the casing and includes an outer sleeve rotatably received in an inner sleeve receiving objects. When the inner sleeve and the objects rotate, the liquids remaining on surfaces of the objects move into the outer sleeve under centrifugal force. The plurality of first buffering members is coupled with the centrifugal device to absorb vibrations in a first direction during operation of the centrifugal device. The plurality of second buffering members abuts against the centrifugal device in a second direction perpendicular to the first direction and absorbs vibrations in the second direction. A liquid collector for receiving the liquids is securely mounted in the casing and intercommunicates with the outer sleeve.

### BACKGROUND OF THE INVENTION

The present invention relates to a solid liquid separator and, more particularly, to a device which uses centrifugal force to separate grease, lubricant, cutting fluid, and/or slurry remaining on surfaces of objects (such as metal workpieces) from the objects.

Grease, lubricant, cutting fluid, and/or slurry may remain on metal workpieces after processing, and rapid, effective separation of a large quantity of the grease, lubricant, cutting fluid, and/or slurry from the surfaces of the metal workpieces is desired. A currently available solid liquid separator uses centrifugal force to rapidly remove the grease, lubricant, cutting fluid, and/or slurry remaining on the metal workpieces.

To achieve the separation, the solid liquid separator must drive the metal workpieces to rotate rapidly, which results in vibrations of the solid liquid separator. The vibrations cause collision of the workpieces and, thus, may damage the workpieces. To reduce the vibrations, the rotating speed of the workpieces must be reduced, leading to insufficient centrifugal force, such that the separation of the grease, cutting fluid, and/or slurry from the metal workpieces is inefficient.

### BRIEF SUMMARY OF THE INVENTION

The present invention provides a solid liquid separator comprising:
a casing including a first space and a second space;
a buffering mechanism securely mounted in the first space and including a plurality of first buffering members and a plurality of second buffering members;
a centrifugal device received in the first space and including an outer sleeve having a space, wherein the outer sleeve is rotatably received in an inner sleeve configured for receiving a plurality of objects, with liquids remaining on surfaces of the plurality of objects, wherein when the inner sleeve and the plurality of objects rotate, the liquids move into the space of the outer sleeve under action of centrifugal force, wherein the plurality of first buffering members is coupled with the centrifugal device to absorb vibrations in a first direction parallel to a longitudinal direction during operation of the centrifugal device, wherein the plurality of second buffering members abuts against the centrifugal device in a second direction perpendicular to the first direction and absorbs vibrations in the second direction caused by the centrifugal device; and a liquid collector securely mounted in the second space and intercommunicating with the outer sleeve, wherein the liquid collector is configured to receive the liquids from the space of the outer sleeve.

Thus, the buffering mechanism may stop and/or absorb vibrations of the centrifugal device in each direction during operation, such that the objects may rotate rapidly and smoothly, thereby separating the liquids (grease, lubricant, cutting fluid, and/or slurry) from the objects.

In an example, the centrifugal device includes an inner frame including two supporting walls and a bottom wall interconnected between the two supporting walls. The bottom wall is coupled with the plurality of first buffering members. The plurality of second buffering members abuts against two outer surfaces respectively of the two supporting walls. The outer sleeve is located between the two supporting walls and is spaced from the bottom wall.

In an example, the buffering mechanism further includes a plurality of third buffering members. Each of the plurality of third buffering members abuts against the centrifugal device in a third direction perpendicular to the first and second directions and absorbs vibrations of the centrifugal device in the third direction.

Each first buffering member may stop and/or absorb vibrations of the centrifugal device in the first direction, each second buffering member may stop and/or absorb vibrations of the centrifugal device in the second direction, and each third buffering member may stop and/or absorb vibrations of the centrifugal device in the third direction. Thus, the vibrations in all directions during operation of the centrifugal device can be effectively absorbed.

In an example, the centrifugal device includes an inner frame including two supporting walls and a bottom wall interconnected between the two supporting walls. The bottom wall of the inner frame further includes two end faces located between the two supporting walls. The bottom wall is coupled with the plurality of first buffering members. The plurality of second buffering members abuts against two outer surfaces respectively of the two supporting walls. The plurality of third buffering members abuts against the two end faces. The outer sleeve is located between the two supporting walls and is spaced from the bottom wall.

In an example, the inner frame further includes an outer coupling portion securely mounted to one of the two supporting walls. The centrifugal device further includes two bearings respectively mounted to the two supporting walls. The outer sleeve is rotatably supported by the two bearings to be rotatable about a rotating axis parallel to the second direction. An inclined driving member is rotatably mounted to the outer coupling portion. The outer sleeve and the inclined driving member are coupled with each other to permit joint movement of the outer sleeve and the inclined driving member. The centrifugal device further includes a rotational driving member mounted outside of the outer sleeve and configured to drive the inner sleeve to rotate. The casing further includes a conveying member extending into the first space. The inclined driving member is actuatable to move the inner sleeve, the outer sleeve, and the rotational driving member between a first position and a second position. When the inner sleeve is in the first position, a rotating axis of the inner sleeve is parallel to the first direction. When the inner sleeve is in the second position, the rotating axis of the inner sleeve is at a non-parallel angle to the first direction, and wherein the plurality of objects in the inner sleeve move from the inner sleeve to the conveying member.

When the inner sleeve is in the second position, the extension is located between the inner end and the outer end of the conveying member to assure that the objects will not fall into the first space while the objects is moving from the inner sleeve to the conveying member.

In an example, the casing further includes a partitioning layer between the first space and the second space. The buffering mechanism further includes two first supports securely mounted to the partitioning layer and two second supports securely mounted to the partitioning layer. The buffering mechanism further includes a plurality of connecting members. Each of the plurality of connecting members includes an end securely mounted to the bottom wall of the inner frame and another end securely mounted to a respective one of the two first supports. Each of the plurality of first buffering members is located between the respective one of the two first supports and the centrifugal device and is coupled with an outer side of a respective one of the plurality of connecting members. Each of the plurality of second buffering members is coupled with a respective one of the two second supports and is located between the respective one of the two second supports and the centrifugal device.

In an example, the centrifugal device further includes an inner frame coupled with the plurality of first buffering members. Each of the plurality of second buffering members abuts against the inner frame. The outer sleeve and the inner frame are pivotably coupled to permit pivotal movement of the outer sleeve in a direction parallel to the second direction. The casing further includes a conveying member aligned with the first space, wherein the conveying member includes an inner end located in the first space and an outer end located outside of the casing. The inner sleeve further includes an extension extending beyond the outer sleeve. The outer sleeve actuates the inner sleeve to pivot between a first position in which the rotating axis of the inner sleeve is parallel to the first direction and a second position in which the rotating axis of the inner sleeve is at a non-parallel angle to the first direction. When the inner sleeve is in the first position, the inner end of the conveying member is located between the outer end of the conveying member and the extension. When the inner sleeve is in the second position, the extension is located between the inner end and the outer end of the conveying member, such that the plurality of objects moving from the inner sleeve to the conveying member are prevented from falling into the space.

In an example, the outer sleeve includes a top end. The extension of the inner sleeve is located outside of the top end of the outer sleeve. The inner sleeve further includes a flange extending radially outward from an outer periphery of the inner sleeve. The flange is located between the extension and the top end and covers an outer side of the space, such that the plurality of objects is prevented from falling into the space via a gap between the outer sleeve and the inner sleeve.

The flange of the inner sleeve covers the outer side of the space, such that when the inner sleeve is in the first position and the objects are moving from the feed hopper into the chamber of the inner sleeve, the objects cannot enter the space of the outer sleeve. This assures that the objects and the inner sleeve may rotate together to reliably separate the liquids (grease, lubricant, cutting fluid, and/or slurry) from the objects.

In an example, the outer sleeve further includes an inner stop ring located between the inner periphery of the outer sleeve and an outer periphery of the inner sleeve in a radial direction. The inner stop ring extends toward but is spaced from a bottom end of the outer sleeve. The inner sleeve includes a plurality of holes extending radially from the outer periphery of the inner sleeve through an inner periphery of the inner sleeve and intercommunicating with a chamber of the inner sleeve. The inner stop ring is located between the flange and the plurality of holes in a direction parallel to the rotating axis of the inner sleeve.

When the inner sleeve is in the second position, the liquids (including grease, lubricant, cutting fluid, and/or slurry) remaining on the outer sleeve will be stopped by the inner stop ring and, thus, cannot overflow into the first space via the top end of the outer sleeve. Thus, the first space, the centrifugal device, and the buffering mechanism keep clean and tidy. The inner stop ring is located between the holes and the flange in a direction parallel to the rotating axis of the inner sleeve. Furthermore, the inner stop ring is located between the inner periphery of the outer sleeve and the outer periphery of the inner sleeve in the radial direction of the outer sleeve. Furthermore, the flange covers the space, such that the liquids (including grease, lubricant, cutting fluid, and/or slurry) moving from the inner sleeve toward the space of the outer sleeve under the action of the centrifugal force will not splash through the top end of the outer sleeve into the first space. Thus, the first space, the centrifugal device, and the buffering mechanism keep clean and tidy.

In an example, the solid liquid separator further comprises a liquid level detection device. The liquid collector includes a collection box and a mounting member securely mounted to an outer side of the collection box. The outer sleeve is coupled with and intercommunicates with the collection box. The liquid collector further includes a pump mounted to the mounting member and including a discharge tube extending beyond the casing. The pump is configured to discharge liquids in the collection box through the discharge tube to an outside. The liquid level detection device includes a float movable between a lower position and a higher position, wherein when the float is in the lower position, the pump is not activated. When the float is in the higher position, the pump is activated to discharge the liquids in the collection box out of the casing.

In an example, the collection box includes a collection chamber. The liquid level detection device further includes a positioning member mounted on the mounting member and an adjusting member movably mounted to the positioning member. The adjusting member includes an engaging end. The liquid level detection device further includes a limiting rod securely coupled with the engaging end of the adjusting member. The float is movably coupled with the limiting rod. The liquid level detection device further includes a fastener in threading connection with the positioning member. When the fastener is tightened, the adjusting member is prevented from moving relative to the positioning member. When the fastener is loosened, the adjusting member is permitted to move relative to the positioning member to thereby change a spacing between the float and a bottom of the collection chamber.

The adjusting member of the liquid level detection device is adjustable to enable a change in the spacing between the float and the bottom of the collection box, which, in turn, permits a change in the liquid level that will activate or stop the pump.

The present invention will become clearer in light of the following detailed description of illustrative embodiments of this invention described in connection with the drawings.

### DESCRIPTION OF THE DRAWINGS

FIG. 1 is an exploded, perspective view of a solid liquid separator of an embodiment according to the present invention.

FIG. 2 is an exploded, perspective view of a centrifugal device and a buffering device of the solid liquid separator according to the present invention.

FIG. 3 is an exploded, perspective view of a liquid collection device of the solid liquid separator according to the present invention.

FIG. 4 is a perspective view of a portion of the solid liquid separator according to the present invention.

FIG. 5 is a perspective view of the solid liquid separator according to the present invention.

FIG. 6 is a cross sectional view taken along section line 6-6 of FIG. 5.

FIG. 7 is a partial side view of the solid liquid separator according to the present invention.

FIG. 8 is a longitudinal cross sectional view of FIG. 7.

FIG. 9 is a longitudinal cross sectional view of the liquid collection device.

All figures are drawn for ease of explanation of the basic teachings of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “lower”, “upper”, “top”, “bottom”, “inner”, “outer”, “side”, “end”, “portion”, “longitudinal”, “axial”, “radial”, “centrifugal”, “outward”, “spacing”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

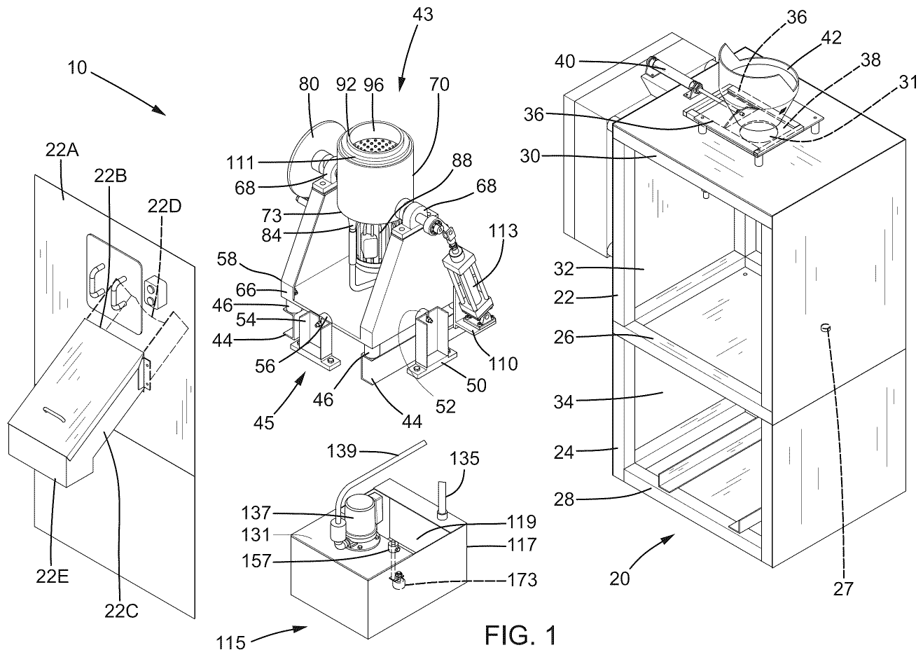

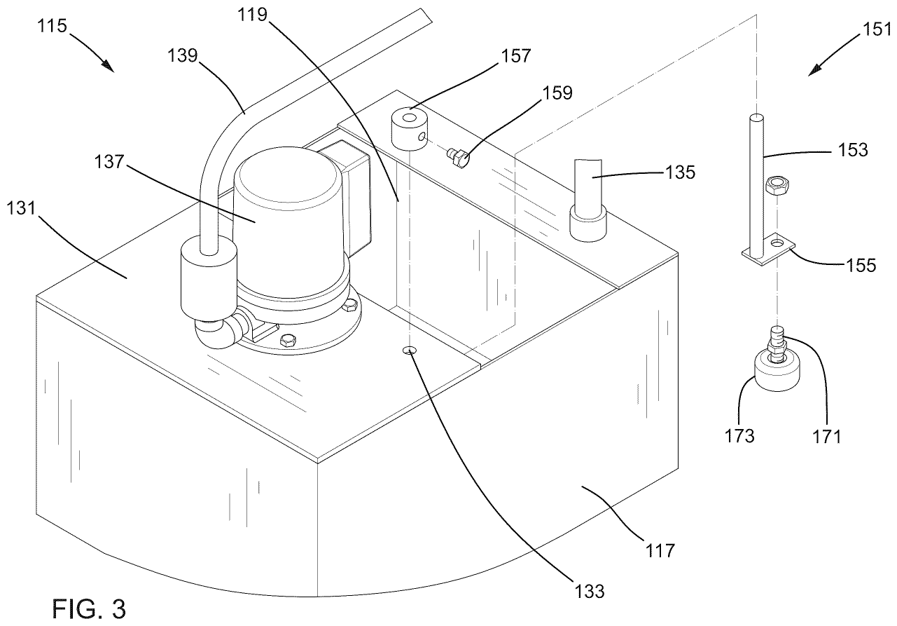

The present invention relates to a solid liquid separator 10 for separating liquids (including grease, lubricant, cutting fluid, and/or slurry) remaining on surfaces of metal workpieces (objects 175). With reference to FIGS. 1-6, the solid liquid separator 10 comprises a casing 20. The casing 20 includes a partitioning layer 26, a first layer shelf 22 securely mounted on top of the partitioning layer 26, and a second layer shelf 24 securely mounted below the partitioning layer 26. The casing 20 further includes a top layer 30 securely mounted to a top end of the first layer shelf 22 and a bottom layer 28 securely mounted to a bottom end of the second layer shelf 24. A first space 32 is formed between the top layer 30 and the partitioning layer 26. A second space 34 is formed between the partitioning layer 26 and the bottom layer 28. The partitioning layer 26 includes a connecting hole 27 intercommunicating the first space 32 with the second space 34.

The top layer 30 includes an upper opening 31 intercommunicating the first space 32 with the space outside the casing 20. The top layer 30 further includes two tracks 36 disposed on an upper surface of the top layer 30 and outside of the upper opening 31. A gate 38 is movably coupled with the two tracks 36. A feed hopper 42 is securely mounted to the top layer 30 and is aligned with the upper opening 31. The gate 38 is located between the upper opening 31 and the feed hopper 42.

An actuating cylinder 40 is mounted outside of the casing 20 and adjacent to the top layer 30. The actuating cylinder 40 includes a piston rod coupled with the gate 38 to thereby control movement of the gate 38. Thus, the gate 38 can be moved to reveal or close the upper opening 31.

The casing 20 further includes a front panel 22A securely mounted to a side of the first layer shelf 22 and aligned with the first space 32. The front panel 22A includes an opening 22B intercommunicating the first space 32 with the space outside the casing 20. A conveying member 22C is securely mounted to the front panel 22A and includes an inner end 22D inside the first space 32 and an outer end 22E outside of the casing 20. The inner end 22D may be but not limited to be arcuate.

The solid liquid separator 10 further comprises a buffering mechanism 45 securely mounted in the first space 32. In this embodiment, the buffering mechanism 45 includes two first supports 44, four first buffering members 46, and four connecting members 48. Each of the two first supports 44 may be in the form of a U-shaped metal frame. Each of the two first supports 44 is securely mounted above the partitioning layer 26 and located in the first space 32. The connecting hole 27 is located between the two first supports 44. Each of the four connecting members 48 has a lower end securely connected to an end of a respective first support 44. Specifically, a pair of first buffering members 46 is disposed on each first support 44. Each connecting member 48 extends in a first direction parallel to a longitudinal direction. Each of the four first buffering members 46 is coupled around a respective connecting member 48 and has a lower end abutting against a respective first support 44. An upper end of each connecting member 48 extends beyond a respective first buffering member 46. Each first buffering member 46 may be but not limited to be made of rubber, silicone rubber, or similar elastic material.

The buffering mechanism 45 further includes two second supports 50, two third supports 54, two second buffering members 52, and two third buffering members 56, all of which are received in the first space 32. The two second supports 50 are symmetrically disposed on the partitioning layer 26. The two third supports 54 are symmetrically disposed on the partitioning layer 26. The two first supports 44 are located between the two second supports 50 in a second direction perpendicular to the first direction. The two third supports 54 are located between the two third supports 54. The two second buffering members 52 are coupled with the two second supports 50 and are spaced from each other in the second direction. The two third buffering members 56 are coupled with the two third supports 54 and are spaced from each other in a third direction perpendicular to the first and second directions. Each of two second buffering members 52 and the two third buffering members 56 may be but not limited to be made of rubber, silicone rubber, or similar elastic material.

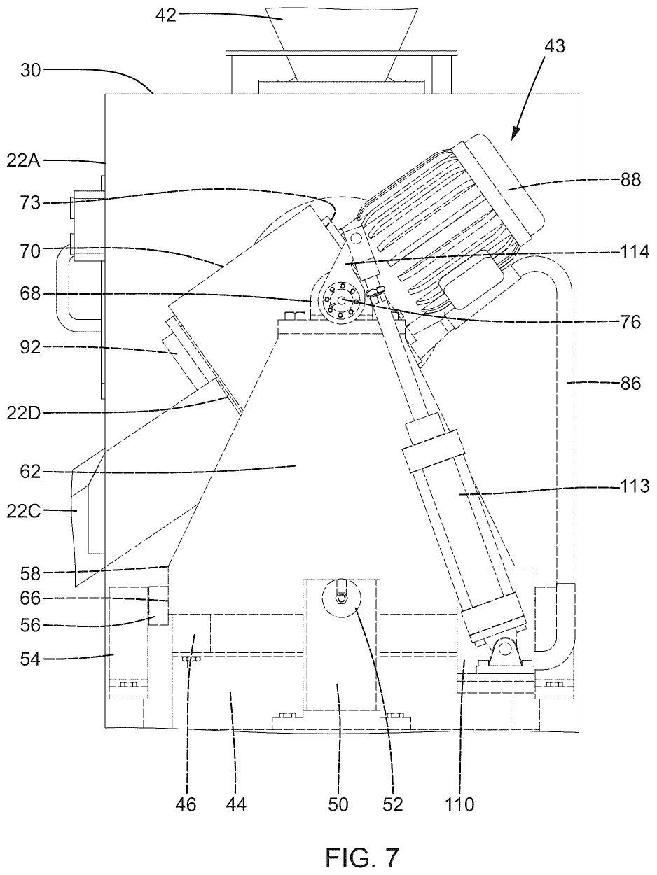

The solid liquid separator 10 further comprises a centrifugal device 43 received in the first space 32 and coupled with the four first buffering members 46. The centrifugal device 43 includes an inner frame 58 having two supporting walls 62 symmetrically disposed and spaced from each other in the second direction and a bottom wall 64 interconnected between two ends respectively of the two supporting walls 62. The bottom wall 64 includes two end faces 66 located between the two supporting walls 62 and spaced from each other in the third direction. Furthermore, one of the two supporting walls 62 includes an outer coupling portion 110 on an outer side thereof. The bottom wall 64 of the inner frame 58 abuts against an upper end of each of the four first buffering members 46. The upper end of each connecting member 48 extends through and is threadedly coupled with the bottom wall 64 of the inner frame 58. Thus, the four first buffering members 46 support the inner frame 58 to be spaced from the partitioning layer 26. Furthermore, the two second buffering members 52 abuts the two supporting walls 62 in the second direction. The two third buffering members 56 abuts the two end faces 66 in the third direction 56 (see FIG. 7).

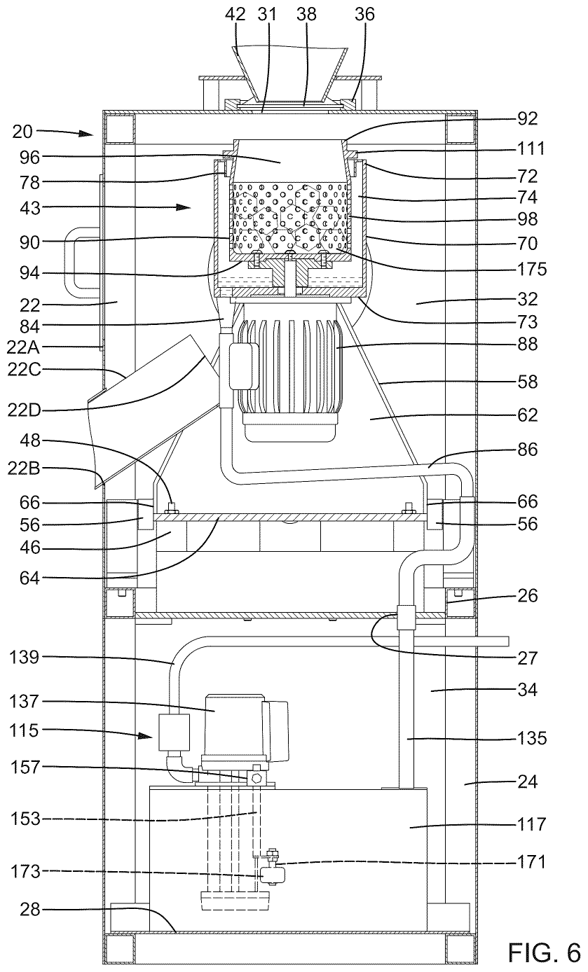

The centrifugal device 43 further includes two bearings 68 respectively mounted on upper ends of the two supporting walls 62 and an outer sleeve 70. The outer sleeve 70 includes a bottom end 73 and a top end 72. Two diametrically disposed shafts 76 extend outward from an outer periphery of the outer sleeve 70 and may rotate about the same rotating axis parallel to the second direction. An inner stop ring 78 is securely received in the outer sleeve 70 and may be securely mounted to an inner periphery of the outer sleeve 70 and located adjacent to a top end 72 of the outer sleeve 70. The inner stop ring 78 extends toward but is spaced from a bottom end 73 of the outer sleeve 70 (see FIG. 6). Furthermore, a drain tube 84 extends from the bottom end 73 of the outer sleeve 70 and intercommunicates with a space 74 defined in the outer sleeve 70. A flexible or elastic connecting tube 86 is connected to the drain tube 84 and includes an end coupled with the connecting hole 27 of the partitioning layer 26. Furthermore, the two shafts 76 on the outer sleeve 70 are rotatably coupled with the two bearings 68, respectively, such that the bottom end 73 of the outer sleeve 70 is maintained to be spaced from and between the two supporting walls 62.

The centrifugal device 43 further includes a connecting member 114 and an inclined driving member 113. The connecting member 114 is pivotably coupled with one of the two shafts 76. The inclined driving member 113 is pivotably coupled with the connecting member 114 and the outer coupling portion 110. The inclined driving member 113 is configured to actuate the connecting member 114 and the outer sleeve 70 to rotate jointly about a rotating axis parallel to the second direction. According to the form shown, the rotating axis is the common central axis of the two shafts 76. Furthermore, the inclined driving member 113 may be but not limited to be formed by a pneumatic cylinder or a hydraulic cylinder.

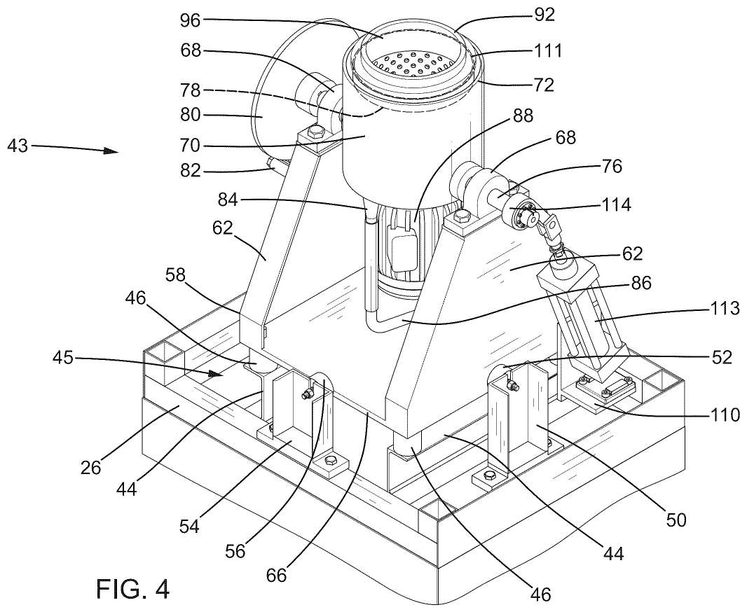

The centrifugal device 43 further includes a brake disc 80 rotatably coupled with another of the two shafts 76. The centrifugal device 43 further includes a brake 82 (see FIG. 4) securely mounted on one of the two supporting walls 62 of the inner frame 58. A portion of the brake disc 80 is located in the brake 82. Thus, when the brake 82 does not securely clamp the brake disc 80, the brake disc 80 will not affect rotation of the outer sleeve 70. On the other hand, when the brake disc 80 is securely clamped by the brake 82, the outer sleeve 70 is prevented from rotating.

The centrifugal device 43 further includes an inner sleeve 90 rotatably received in the outer sleeve 70. The inner sleeve 90 includes a lower end 94 and a chamber 96. The inner sleeve 90 further includes a plurality of holes 98 extending radially through a peripheral wall of the inner sleeve 90 and intercommunicating with the chamber 96. The inner sleeve 90 further includes a flange 111 extending radially outward from an outer peripheral surface of the peripheral wall. The inner sleeve 90 further includes an extension 92 extending outward in a direction parallel to a rotating axis of the inner sleeve 90. The flange 111 is located between the extension 92 and the plurality of holes 98 along the rotating axis of the inner sleeve 90.

A rotational driving member 88 is securely mounted to the bottom end 73 of the outer sleeve 70 and located outside of the space 74. The rotational driving member 88 may be but not limited to be in the form of an electric motor. The rotational driving member 88 includes a shaft sealingly extending through the outer sleeve 70 into the space 74. A portion of the inner sleeve 90 having the plurality of holes 98 is received in the space 74 of the outer sleeve 70. Thus, each of the plurality of holes 98 intercommunicates with the chamber 96 and the space 74. The lower end 94 of the inner sleeve 90 is coupled with the shaft of the rotational driving member 88 to permit joint rotation of the rotational driving member 88 and the inner sleeve 90. The flange 111 and the extension 92 are located outside of the space 74 of the outer sleeve 70 in a direction parallel to the rotating axis of the inner sleeve 90. The inner stop ring 78 is located between the flange 111 and the plurality of holes 98 in a direction (the first direction in FIG. 6) parallel to the rotating axis of the inner sleeve 90. The inner stop ring 78 is located between the inner periphery of the outer sleeve 70 and the outer periphery of the inner sleeve 90 in a radial direction of the outer sleeve 70 and is spaced from the outer periphery of the inner sleeve 90, as shown in FIG. 6. A gap exists between the flange 111 and the top end 72 of the outer sleeve 70 in a direction parallel to the rotating axis of the inner sleeve 90. An extent of the flange 111 in the radial direction of the inner sleeve 90 extends beyond an opening of the space 74, such that the flange 111 covers an outer side of the space 74.

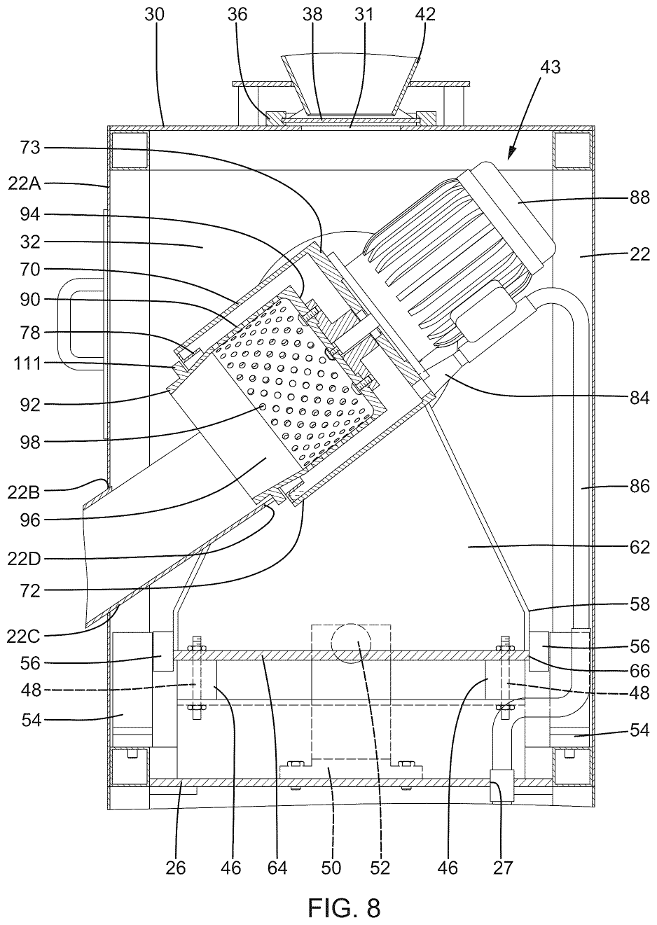

As can be seen from the technical features of the centrifugal device 43, the outer sleeve 70, the inner sleeve 90, the rotational driving member 88, the drain tube 84, and the brake disc 80 are arranged to rotate jointly about the common rotating axis of the two shafts 76. Thus, the inner sleeve 90 can be rotated to a first position in which the rotating axis of the inner sleeve 90 is parallel to the first direction (FIG. 6) or a second position in which the rotating axis of the inner sleeve 90 is at a non-parallel angle to the first direction (FIGS. 7 and 8).

The solid liquid separator 10 further comprises a liquid collector 115 including a collection box 117 having a collection chamber 119. The liquid collector 115 further includes a mounting member 131 securely mounted to a top end of the collection box 117. The mounting member 131 includes an engaging portion 133 which may be but not limited to be in the form of a hole. A pump 137 is securely mounted to the mounting member 131 and includes an end extending into the collection chamber 119. The pump 137 further includes a discharging tube 139 extending to the space outside the casing 20. A guiding tube 135 is disposed between the collection box 117 and the connecting hole 27 of the partitioning layer 26 to intercommunicate with the connecting tube 86.

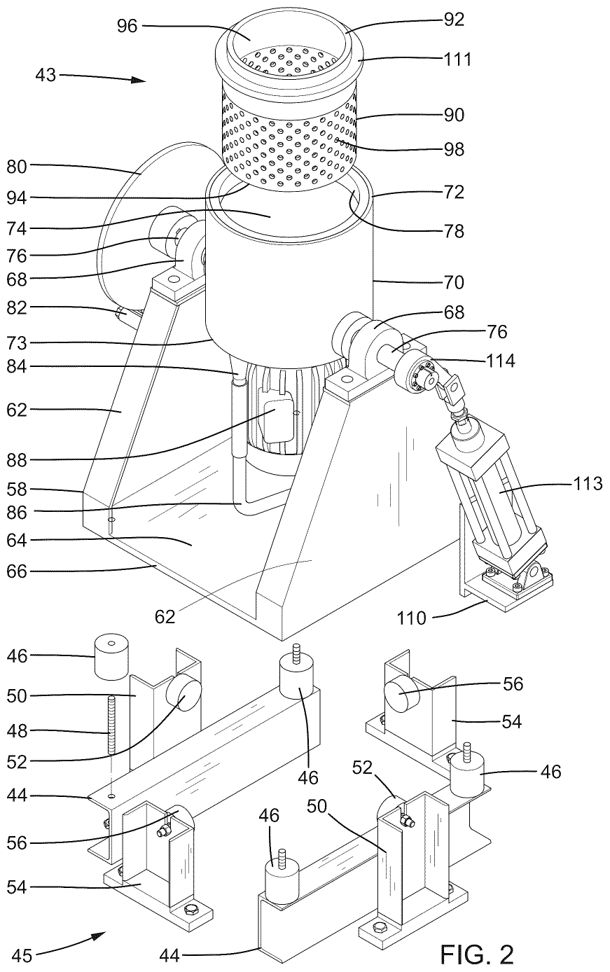

The solid liquid separator 10 further comprises a liquid level detection device 151 securely mounted on the collection box 117. The liquid level detection device 151 includes an adjusting member 153, a positioning member 157, and a fastener 159. The adjusting member 153 includes an engaging end 155 which may be located at a lower end of the adjusting member 153 and in the form of a plate. The positioning member 157 abuts against the mounting member 131. The adjusting member 153 is movably mounted to the engaging portion 133 and the positioning member 157. Specifically, the engaging end 155 of the adjusting member 153 is located inside the collection chamber 119. An end of the adjusting member 153 remote from the engaging end 155 is located outside of the collection box 117. The fastener 159 extends in a radial direction (the second direction in FIG. 2) of the positioning member 157 and is in threading connection with the positioning member 157. When the fastener 159 is loosened, the adjusting member 153 is permitted to move relative to the positioning member 157 to thereby change the spacing between the engaging end 155 and the bottom of the collection chamber 119. When the fastener 159 is tightened, the adjusting member 153 is positioned to prevent movement relative to the positioning member 157.

The liquid level detecting device 151 further comprises a limiting rod 171 and a float 173 movably mounted on the limiting rod 171. The limiting rod 171 is securely mounted on the engaging end 155 of the adjusting member 153. The float 173 and the limiting rod 171 may be provided with two poles of a reed switch. When the float 173 does not provide buoyant force, the two poles of the reed switch are disconnected, such that the pump 137 does not operate. On the other hand, when the float 173 provides buoyant force, the two poles of the reed switch are induced to activate the pump 137.

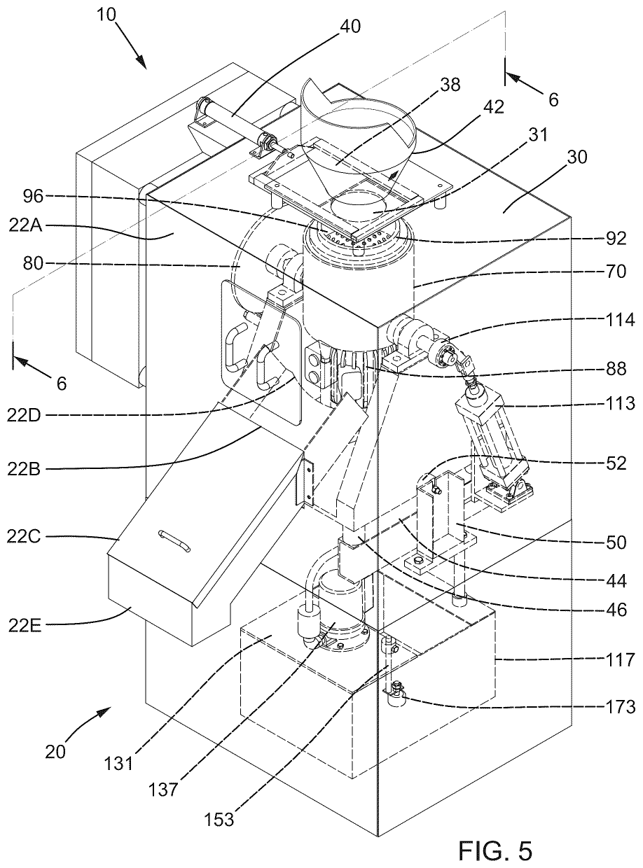

Operation of the solid liquid separator 10 will now be set forth. With reference to FIGS. 5 and 6, assuming the inner sleeve 90 is in the first position, the inner end 22D of the conveying member 22C is located between the outer end 22E and the extension 92 in the third direction, as shown in FIG. 6. In this state, the extension 92 is adjacent to the upper opening 31 in the first direction, and the chamber 96 is aligned with the upper opening 31. The gate 38 seals the upper opening 31. A plurality of objects 175(such as metal workpieces) may be placed into the feed hopper 42. Liquids (including grease, lubricant, cutting fluid, and/or slurry may remain on surfaces of the objects 175 after processing. Since, the upper opening 31 is sealed, the objects 175 will not fall into the chamber 96 of the inner cylinder 90.

When the gate 38 displaces to reveal the upper opening 31, the objects 175 fall into the chamber 96 of the inner sleeve 90. While the objects 175 are falling into the chamber 96, the flange 111 prevents small items (such as screws) from entering the space 74 via the gap between the outer sleeve 70 and the inner sleeve 90.

After the objects 175 are received in the chamber 96 of the inner cylinder 90, the rotational driving member 88 drives the inner cylinder 90 and the objects 175 to rotate. Fluid (such as cutting fluid, grease, lubricant, and/or slurry) remaining on or stick to the surfaces of the objects 175 will separate from the objects 175 under the action of centrifugal force. The separated liquids pass through the holes 98 of the inner cylinder 90 and enter the space 74 of the outer sleeve 70. Next, the liquids in the space 74 pass through the drain tube 84, the connecting tube 86, and the guiding tube 135 to enter the collection box 117.

It is noted that when the inner cylinder 90 is in the first position and is rotating, the brake 82 may position the brake disc 80 (such as by clamping or other mechanisms), such that the inner sleeve 90 and the objects 175 therein may rotate rapidly without deviation of the rotating axis of the inner sleeve 90. Thus, the outer sleeve 70 and the inner sleeve 90 may be retained in the first position more stably.

During the rotation of the inner sleeve 90 and the objects 175, the vibrations caused by the centrifugal device 43 are stopped and/or absorbed by the first buffering members 46, the second buffering members 52, and the third buffering members 56. Specifically, each first buffering member 46 may stop and/or absorb vibrations of the centrifugal device 43 in the first direction, each second buffering member 52 may stop and/or absorb vibrations of the centrifugal device 43 in the second direction, and each third buffering member 56 may stop and/or absorb vibrations of the centrifugal device 43 in the third direction. Thus, rotation of the inner sleeve 90 of the centrifugal device 43 is smoother.

After the liquids residing on or stick to the objects 175 are separated, the rotational driving member 88 is stopped to stop rotation of the inner sleeve 90. Next, the inclined driving member 113 is operated. With reference to FIGS. 6-8, the outer sleeve 70, the inner sleeve 90, the rotational driving member 88, and the brake disc 80 pivot jointly to a position in which the inner sleeve 90 is in the second position. In this state, the chamber 96 of the inner sleeve 90 faces the opening 22B of the conveying member 22C, and the extension 92 is located between the inner end 22D and the outer end 22E of the conveying member 22C. Since the inner sleeve 90 in the second position is inclined, the objects 175 in the chamber 96 will move toward the conveying member 22C under the action of gravitational force. The conveying member 22C guides the object 175 to move to the outside of the solid liquid separator 10.

During movement of the objects 175 from the inner sleeve 90 toward the conveying member 22C, the gap between the inner end 22D of the conveying member 22C and the inner sleeve 90 is covered by the extension 92 to prevent the objects 175 in the form of small items (such as screws) from falling into the first space 32 of the casing 20.

It is noted that when the inner sleeve 90 is in the first position, in a case that the brake 82 clamps the brake disc 80, after the inner sleeve 90 is stopped, the brake disc 80 must be released before pivoting the inner sleeve 90 from the first position to the second position. Specifically, after the brake 82 releases the brake disc 80, the inclined driving member 113 is operated to pivot the inner sleeve 90 from the first position to the second position. When the inner sleeve 90 is in the second position, the brake 82 may clamp the brake disc 80 to more securely retain the inner sleeve 90 in the second position.

When the liquid level of the separated liquids in the collection chamber 119 is lower than the float 173 of the liquid level detection device 151, the float 173 is in a lower position (FIG. 6) not activing the pump 137. When the liquid level of the separated liquids in the collection chamber 119 is high and moves the float 173 to a higher position, the pump 137 is activated to discharge the separated liquids to the outside of the solid liquid separator 10 via the discharge tube 139, such as to a large storage tank. Therefore, the separated liquids in the collection chamber 119 of the collection box 117 will not overflow.

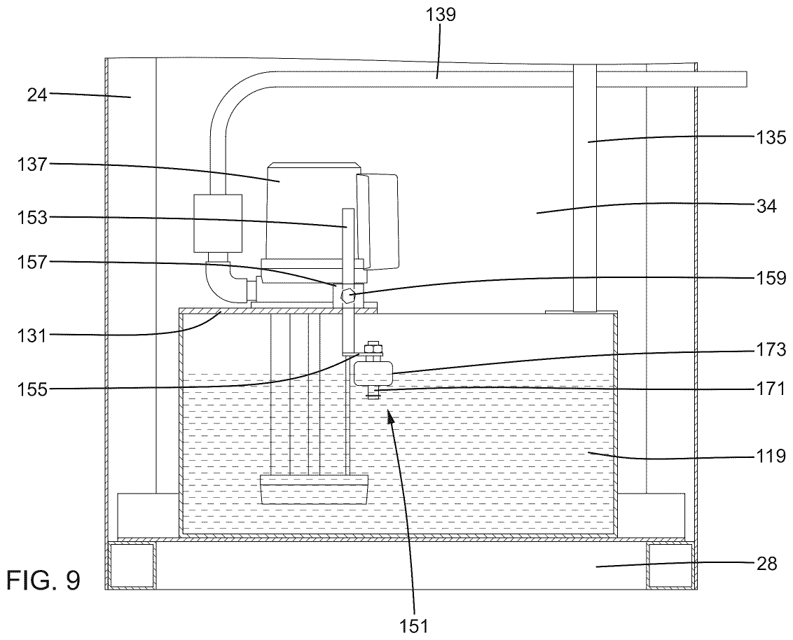

Furthermore, with reference to FIG. 9, the adjusting member 153 may be used to adjust the spacing between the float 173 and the bottom of the collection chamber 119. Thus, the pump 137 will stop or operate when the separated liquids in the collection chamber 119 reaches a predetermined level.

Since the technical features of the solid liquid separator 10 according to the present invention have been set forth, the following advantages of the solid liquid separator 10 according to the present invention may be appreciated. Firstly, the buffering mechanism 45 may stop and/or absorb vibrations of the centrifugal device 43 in each direction during operation, such that the objects 175 may rotate rapidly and smoothly, thereby separating the liquids (grease, lubricant, cutting fluid, and/or slurry) from the objects 175.

Each first buffering member 46 may stop and/or absorb vibrations of the centrifugal device 43 in the first direction, each second buffering member 52 may stop and/or absorb vibrations of the centrifugal device 43 in the second direction, and each third buffering member 56 may stop and/or absorb vibrations of the centrifugal device 43 in the third direction. Thus, the vibrations in all directions during operation of the centrifugal device 43 can be effectively absorbed.

When the inner sleeve 90 is in the second position, the extension 92 is located between the inner end 22D and the outer end 22E of the conveying member 22C to assure that the objects 175 will not fall into the first space 32 while the objects 175 is moving from the inner sleeve 90 to the conveying member 22C.

The flange 111 of the inner sleeve 90 covers the outer side of the space 74, such that when the inner sleeve 90 is in the first position and the objects 175 are moving from the feed hopper 42 into the chamber 96 of the inner sleeve 90, the objects 175 cannot enter the space 74 of the outer sleeve 70. This assures that the objects 175 and the inner sleeve 90 may rotate together to reliably separate the liquids (grease, lubricant, cutting fluid, and/or slurry) from the objects 175.

When the inner sleeve 90 is in the second position, the liquids (including grease, lubricant, cutting fluid, and/or slurry) remaining on the outer sleeve 70 will be stopped by the inner stop ring 78 and, thus, cannot overflow into the first space 32 via the top end 72 of the outer sleeve 70. Thus, the first space 32, the centrifugal device 43, and the buffering mechanism 45 keep clean and tidy.

The inner stop ring 78 is located between the holes 98 and the flange 111 in a direction parallel to the rotating axis of the inner sleeve 90. Furthermore, the inner stop ring 78 is located between the inner periphery of the outer sleeve 70 and the outer periphery of the inner sleeve 90 in the radial direction of the outer sleeve 70. Furthermore, the flange 111 covers the space 74, such that the liquids (including grease, lubricant, cutting fluid, and/or slurry) moving from the inner sleeve 90 toward the space 74 of the outer sleeve 70 under the action of the centrifugal force will not splash through the top end 72 of the outer sleeve 70 into the first space 32. Thus, the first space 32, the centrifugal device 43, and the buffering mechanism 45 keep clean and tidy.

The adjusting member 153 of the liquid level detection device 151 is adjustable to enable a change in the spacing between the float 173 and the bottom of the collection box 117, which, in turn, permits a change in the liquid level that will activate or stop the pump 137.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A solid liquid separator comprising:
a casing including a first space and a second space;
a buffering mechanism securely mounted in the first space and including a plurality of first buffering members and a plurality of second buffering members;
a centrifugal device received in the first space and including an outer sleeve having a space, wherein the outer sleeve is rotatably received in an inner sleeve configured for receiving a plurality of objects, with liquids remaining on surfaces of the plurality of objects, wherein when the inner sleeve and the plurality of objects rotate, the liquids move into the space of the outer sleeve under action of centrifugal force, wherein the plurality of first buffering members is coupled with the centrifugal device to absorb vibrations in a first direction parallel to a longitudinal direction during operation of the centrifugal device, wherein the plurality of second buffering members abuts against the centrifugal device in a second direction perpendicular to the first direction and absorbs vibrations in the second direction caused by the centrifugal device; and
a liquid collector securely mounted in the second space and intercommunicating with the outer sleeve, wherein the liquid collector is configured to receive the liquids from the space of the outer sleeve.

2. The solid liquid separator as claimed in claim 1, wherein the centrifugal device includes an inner frame including two supporting walls and a bottom wall interconnected between the two supporting walls, wherein the bottom wall is coupled with the plurality of first buffering members, wherein the plurality of second buffering members abuts against two outer surfaces respectively of the two supporting walls, and wherein the outer sleeve is located between the two supporting walls and is spaced from the bottom wall.

3. The solid liquid separator as claimed in claim 1, wherein the buffering mechanism further includes a plurality of third buffering members, wherein each of the plurality of third buffering members abuts against the centrifugal device in a third direction perpendicular to the first and second directions and absorbs vibrations of the centrifugal device in the third direction.

4. The solid liquid separator as claimed in claim 3, wherein the centrifugal device includes an inner frame including two supporting walls and a bottom wall interconnected between the two supporting walls, wherein the bottom wall of the inner frame further includes two end faces located between the two supporting walls, wherein the bottom wall is coupled with the plurality of first buffering members, wherein the plurality of second buffering members abuts against two outer surfaces respectively of the two supporting walls, wherein the plurality of third buffering members abuts against the two end faces, and wherein the outer sleeve is located between the two supporting walls and is spaced from the bottom wall.

5. The solid liquid separator as claimed in claim 2, wherein the inner frame further includes an outer coupling portion securely mounted to one of the two supporting walls, wherein the centrifugal device further includes two bearings respectively mounted to the two supporting walls, wherein the outer sleeve is rotatably supported by the two bearings to be rotatable about a rotating axis parallel to the second direction, wherein an inclined driving member is rotatably mounted to the outer coupling portion, wherein the outer sleeve and the inclined driving member are coupled with each other to permit joint movement of the outer sleeve and the inclined driving member, wherein the centrifugal device further includes a rotational driving member mounted outside of the outer sleeve and configured to drive the inner sleeve to rotate, wherein the casing further includes a conveying member extending into the first space, wherein the inclined driving member is actuatable to move the inner sleeve, the outer sleeve, and the rotational driving member between a first position and a second position, wherein when the inner sleeve is in the first position, a rotating axis of the inner sleeve is parallel to the first direction, and wherein when the inner sleeve is in the second position, the rotating axis of the inner sleeve is at a non-parallel angle to the first direction, and wherein the plurality of objects in the inner sleeve move from the inner sleeve to the conveying member.

6. The solid liquid separator as claimed in claim 1, wherein the casing further includes a partitioning layer between the first space and the second space, wherein the buffering mechanism further includes two first supports securely mounted to the partitioning layer and two second supports securely mounted to the partitioning layer, wherein the buffering mechanism further includes a plurality of connecting members, wherein each of the plurality of connecting members includes an end securely mounted to the bottom wall of the inner frame and another end securely mounted to a respective one of the two first supports, wherein each of the plurality of first buffering members is located between the respective one of the two first supports and the centrifugal device and is coupled with an outer side of a respective one of the plurality of connecting members, wherein each of the plurality of second buffering members is coupled with a respective one of the two second supports and is located between the respective one of the two second supports and the centrifugal device.

7. The solid liquid separator as claimed in claim 1, wherein the centrifugal device further includes an inner frame coupled with the plurality of first buffering members, wherein each of the plurality of second buffering members abuts against the inner frame, wherein the outer sleeve and the inner frame are pivotably coupled to permit pivotal movement of the outer sleeve in a direction parallel to the second direction, wherein the casing further includes a conveying member aligned with the first space, wherein the conveying member includes an inner end located in the first space and an outer end located outside of the casing, wherein the inner sleeve further includes an extension extending beyond the outer sleeve, wherein the outer sleeve actuates the inner sleeve to pivot between a first position in which the rotating axis of the inner sleeve is parallel to the first direction and a second position in which the rotating axis of the inner sleeve is at a non-parallel angle to the first direction, wherein when the inner sleeve is in the first position, the inner end of the conveying member is located between the outer end of the conveying member and the extension, wherein when the inner sleeve is in the second position, the extension is located between the inner end and the outer end of the conveying member, such that the plurality of objects moving from the inner sleeve to the conveying member are prevented from falling into the space.

8. The solid liquid separator as claimed in claim 1, wherein the outer sleeve includes a top end, wherein the extension of the inner sleeve is located outside of the top end of the outer sleeve, wherein the inner sleeve further includes a flange extending radially outward from an outer periphery of the inner sleeve, wherein the flange is located between the extension and the top end and covers an outer side of the space, such that the plurality of objects is prevented from falling into the space via a gap between the outer sleeve and the inner sleeve.

9. The solid liquid separator as claimed in claim 8, wherein the outer sleeve further includes an inner stop ring located between the inner periphery of the outer sleeve and an outer periphery of the inner sleeve in a radial direction, wherein the inner stop ring extends toward but is spaced from a bottom end of the outer sleeve, wherein the inner sleeve includes a plurality of holes extending radially from the outer periphery of the inner sleeve through an inner periphery of the inner sleeve and intercommunicating with a chamber of the inner sleeve, and wherein the inner stop ring is located between the flange and the plurality of holes in a direction parallel to the rotating axis of the inner sleeve.

10. The solid liquid separator as claimed in claim 1, further comprising a liquid level detection device, wherein the liquid collector includes a collection box and a mounting member securely mounted to an outer side of the collection box, wherein the outer sleeve is coupled with and intercommunicates with the collection box, wherein the liquid collector further includes a pump mounted to the mounting member and including a discharge tube extending beyond the casing, wherein the pump is configured to discharge liquids in the collection box through the discharge tube to an outside, wherein the liquid level detection device includes a float movable between a lower position and a higher position, wherein when the float is in the lower position, the pump is not activated, wherein when the float is in the higher position, the pump is activated to discharge the liquids in the collection box out of the casing.

11. The solid liquid separator as claimed in claim 10, wherein the collection box includes a collection chamber, wherein the liquid level detection device further includes a positioning member mounted on the mounting member and an adjusting member movably mounted to the positioning member, wherein the adjusting member includes an engaging end, wherein the liquid level detection device further includes a limiting rod securely coupled with the engaging end of the adjusting member, wherein the float is movably coupled with the limiting rod, wherein the liquid level detection device further includes a fastener in threading connection with the positioning member, wherein when the fastener is tightened, the adjusting member is prevented from moving relative to the positioning member, and wherein when the fastener is loosened, the adjusting member is permitted to move relative to the positioning member to thereby change a spacing between the float and a bottom of the collection chamber.
